(19) United States
(12) Patent Application Publication
(10) Pub. No.: US 2011/0301834 A1
(43) Pub. Date: Dec. 8, 2011

(54) DEVICE AND METHOD FOR VEHICLE NAVIGATION

(75) Inventor: SHENG-HUEI TAO, Taoyuan (TW)

(73) Assignee: FOXCONN COMMUNICATION TECHNOLOGY CORP., Taoyuan County (TW)

(21) Appl. No.: 12/837,430

(22) Filed: Jul. 15, 2010

(30) Foreign Application Priority Data
Jun. 7, 2010 (TW) 99118365

(51) Int. Cl. G01C 21/00; G01S 19/42

(52) U.S. Cl. 701/201; 701/208

(57) ABSTRACT

A method and an electronic device enables warning in a wrong way driving of a vehicle navigation. The electronic device sets a target location for navigation and presets a determination distance for checking whether on a path of a navigation route. Then, the electronic device starts a direction module and an altitude module to detect a direction variation and an elevation variation of the electronic device to check whether on the path of a navigation route. If one of the results detected by the direction module and the altitude module is different to the information stored in the map, the electronic device issues a notification.

### BACKGROUND

1. Technical Field

Embodiments of the present disclosure relate to vehicle navigation, and in particular, to an electronic device and method providing constant navigation to a moving vehicle.

2. Description of Related Art

Navigation devices for vehicles are well known, widely used, and are becoming increasingly popular. For example, GPS units provide the ability to calculate a current position and display map, route, and location information. GPS units also have the ability to calculate a direction of travel, and vehicle directions for an estimated navigation route, by determining the movement of a user over time. However, these GPS units are unable to provide such functions if no GPS signal is detected or at certain speeds. When a vehicle is in a tunnel or underpass with no GPS signal received the navigation assistance is unavailable

What is needed, therefore, is an electronic device and method to overcome the limitations described.

### BRIEF DESCRIPTION OF THE DRAWINGS

FIG. 1 is a block diagram of one embodiment of an electronic device for vehicle navigation.

FIG. 2 is a flowchart of one embodiment of a vehicle navigation method using an electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used herein, refers to logic embodied in hardware or firmware, or to a collection of software instructions, written in a programming language, such as, for example, Java, C, or assembly. One or more software instructions in the module may be embedded in firmware, such as an EPROM. It will be appreciated that module may comprise connected logic units, such as gates and flip-flops, and may comprise programmable units, such as programmable gate arrays or processors. The module described herein may be implemented as either software and/or hardware module and may be stored in any type of computer-readable medium or other computer storage device.

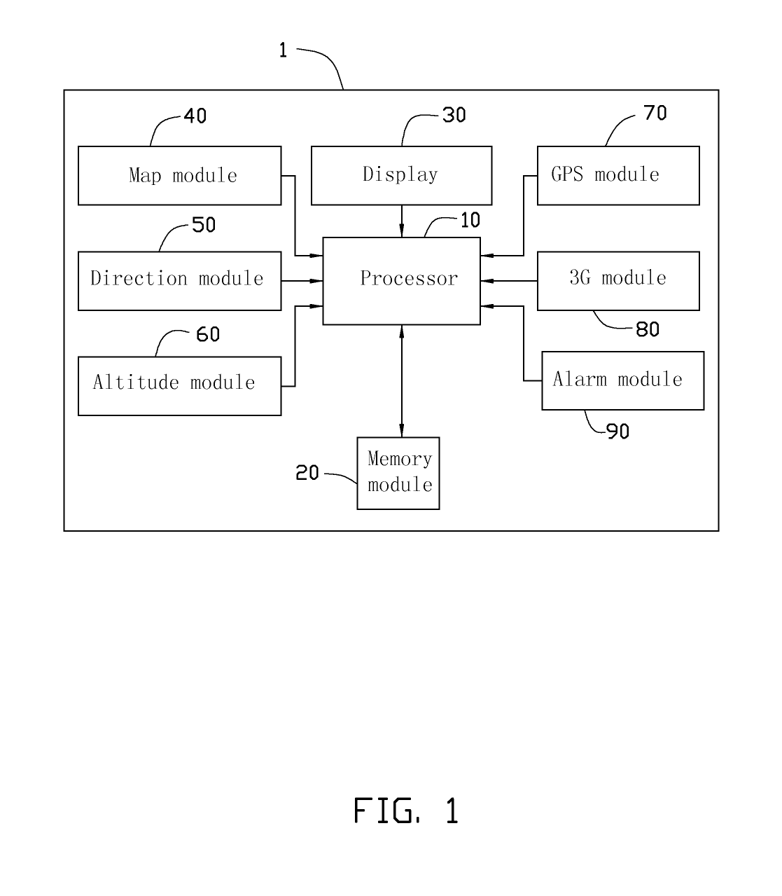

FIG. 1 is a block diagram of one embodiment of an electronic device 1 for vehicle navigation. The electronic device 1 determines whether a vehicle is en route by detecting elevation variation and direction variation of the vehicle. Depending on the embodiment, the electronic device 1 can be a dedicated navigation device or a personal digital assistant (PDA), a mobile phone, or a handheld computer. The electronic device 1 includes a processor 10, a memory module 20 and a display 30, a map module 40, a direction module 50, an altitude module 60, a GPS module 70, a 3G module 80, and an alarm module 90.

The electronic device 1 is generally controlled and coordinated by operating system software, such as the UNIX, Linux, Windows 95, 98, NT, 2000, XP, Vista, Mac OS X, an embedded operating system, or any other compatible operating systems. In other embodiments, the electronic device 1 may be controlled by a proprietary operating system. Conventional operating systems control and schedule computer processes for execution, perform memory management, provide file system, networking, and I/O services, and provide a user interface, such as a graphical user interface (GUI), among other things.

The map module 40 is operable to provide geographic information to the electronic device 1. The direction module 50 detects direction variation of the electronic device 1. The altitude module 60 detects an elevation variation of the electronic device 1. The GPS module 70 provides a current location of the electronic device 1. The 3G module 80 is operable to access the Internet and determine a position of the electronic device 1. The alarm module 90 is operable to issue a notification upon detecting that the detected direction variation or the detected elevation variation of the electronic device 1 differs from information stored in the map module 40. The memory module 20 is operable to save data or information. The display 30 is operable to show geographic information on a screen. The processor 10 is operable to execute one or more computerized codes of the modules stored in the memory module 20 and executed by the processor 10. The processor 10, as an example, may include a CPU, math coprocessor, shift register, for example.

The memory module 20 is operable to save data or information from the processor 10, the map module 40, the direction module 50, the altitude module 60, the GPS module 70, or the 3G module 80. The memory module 20 may include a hard disk drive, flash memory, RAM, ROM, cache, or external storage media.

The display 30 is operable to display information on the screen. The display unit 30 may be a display screen, a resistive touch screen or a capacitive touch screen.

The map module 40 is operable to provide geographic information to the electronic device 1. The geographic information includes attribute map data, such as roads, buildings, rivers, and place-names. In addition, the geographic information further includes geographical coordinates of the data, such as conventional latitude, longitude, and altitude. The map module 40 is electronically connected to the processor 10. In one embodiment, the map module 40 is an electronic map information database on the Internet. The electronic device 1 accesses the electronic map information database via a network, such as a 3G module.

The direction module 50 is operable to detect direction variation of the electronic device 1. In one embodiment, the direction module 50 is an electronic compass. The electronic compass provides 3-axis information of the electronic device 1 and further determines the orientation of the electronic device 1 relative the Earth's magnetic field and generates orientation data. For example, the electronic compass can determine two orientations of the electronic device 1 installed in a driving vehicle at two time points and then calculate the difference between the two orientations during the two time points and save the result to the memory module 20. The direction module 50 continually detects direction variation of the electronic device 1 until the electronic device 1 passes a bifurcation point. The bifurcation point is a junction on a path of navigation route of the map of the vehicle. For example, on the path of navigation route, the bifurcation point can be a closest intersection, or a closest turn to the vehicle in the current location.

The altitude module 60 is operable to detect elevation variation of the electronic device 1 during a period of time. The altitude module 60 is electrically connected to the processor 10. In one embodiment, the altitude module 60 is a G-sensor. The G-sensor is operable to measure a longitudinal acceleration or deceleration of the electronic device 1 and utilize the measured value to generate a corresponding signal of the elevation variation. For example, if a vehicle is driving in an uphill tunnel, the G-sensor detects the longitudinal deceleration of the electronic device 1 and generates a corresponding signal of elevation variation. Alternatively, the G-sensor detects longitudinal acceleration of the electronic device 1 if the vehicle is driving in a downhill tunnel, then generates a corresponding signal of elevation variation. The G-sensor transmits the result to the memory module 20. The altitude module 60 continually detects elevation variation of the electronic device 1 until the electronic device 1 passes a bifurcation point, such as a closest intersection, or a closet turn to the current location of the vehicle.

The GPS module 70 is operable to provide a current location of the electronic device 1. The GPS module 70 is operable to calculate a current location of the electronic device 1 based on latitude, longitude and height by trigonometric measurement which measures accurate time and distance from three or more satellites and uses 3 different distance values. The GPS module 70 obtains time and distance information from 3 satellites and corrects an error with one satellite. In addition, the GPS module 70 further obtains speed information by continuously calculating the current location of the electronic device 1 in real-time. Then, the GPS module 70 provides the calculated location information to the processor 10 and the processor 10 reads the corresponding geographic information from the map module 40 according to the calculated location information.

The processor 10 is operable to estimate a navigation route of a car. In one embodiment, the processor 10 receives the predetermined logic output values from the GPS module 70 and reads the geographic information from the map module 40. Accordingly, the processor 10 reads the geographic information corresponding to the current location of the vehicle and estimates the navigation route between a preset target location and the current location.

The processor 10 is further operable to determine whether the electronic device 1 is conforming to the navigation route. In other embodiments, after the processor 10 estimates the navigation route between a preset target location and the current location, the processor 10 determines the nearest bifurcation point in the navigation route from the map module 40, representing a bifurcation in the navigation route closest to the current location of the electronic device 1. Furthermore, the processor 10 reads a determination distance from the memory module 20 and calculates whether the distance between the current location and the nearest bifurcation point is smaller than the determination distance. The processor 10 sends a digital signal to initiate the direction module 50 and the altitude module 60 to detect direction and elevation variations of the electronic device 1 to determine whether the electronic device 1 is conforming to the navigation route. If any of the detected information is different to the saved geographic information, the processor 10 issues a notification to the alarm module 90. The processor 10 further determines whether the current location is nearing the closest bifurcation point.

The alarm module 90 is operable to receive the alarm signal from the processor 10 and generate an alert accordingly, then transmit the alert to the display 30 and/or a speaker of the electronic device 1, depending on whether the alert is a visual or audio alert.

The 3G module 80 is operable to access the Internet via network and determine a position of the electronic device 1 by peer-to-peer location technology via base stations. In one embodiment, the 3G module 80 accesses an electronic map information database stored in servers via the network, such as Google Maps. In other embodiments, if the electronic device 1 cannot receive GPS signals from the GPS module 70, the 3G module 80 further estimates the location of electronic device 1 in a wireless communication network, based on estimated distances to a plurality of terrestrial reference base stations using error minimizing techniques, such as Gaussian postulate.

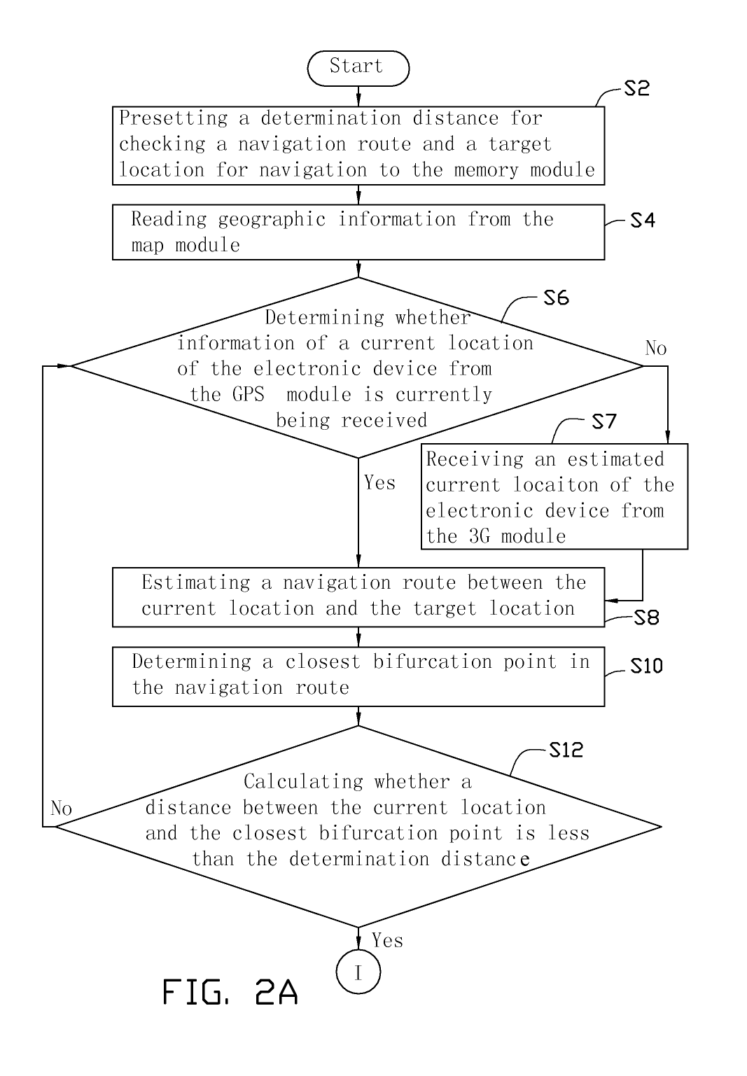

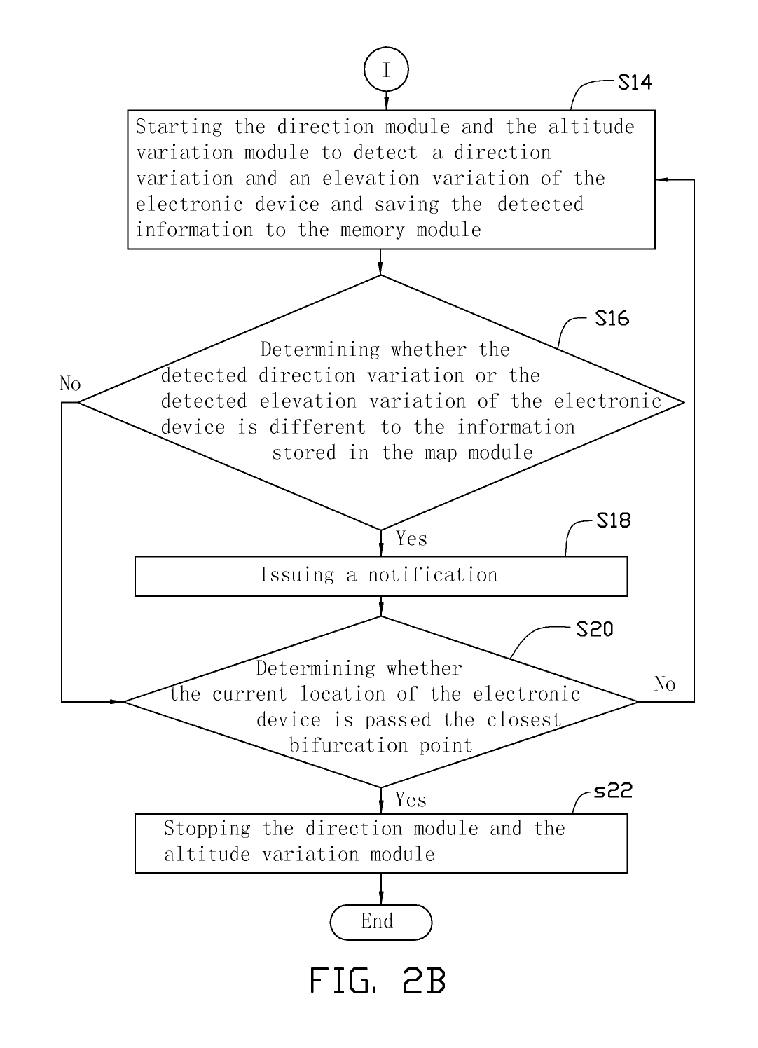

FIG. 2 is a flowchart of one embodiment of a navigation method using an electronic device. Depending on the embodiment, additional blocks may be added, others deleted, and the ordering of the blocks may be changed.

In block S2, a determination distance for checking a navigation route and a target location for navigation to the memory module 20 are preset.

In block S4, the processor 10 reads geographic information from the map module 40.

In block S6, the processor 10 determines whether information of a current location of the electronic device is received from the GPS module 70.

In block S7, the processor 10 receives an estimated current location of the electronic device 1 from a 3G module of the electronic device 1 upon detecting that the current location information of the electronic device 1 from the GPS module 70 is missed.

In block S8, the processor 10 estimates a navigation route between the current location and the target location upon receiving information of the current location of the electronic device 1 from the GPS module 70.

In block S10, the processor 10 determines the nearest bifurcation point in the navigation route from the map module 40, in which the closest bifurcation point is the shortest distance from the current location.

In block S12, the processor 10 calculates whether a distance between the current location and the nearest bifurcation point is less than the determination distance.

In block S14, the processor 10 starts the direction module 50 and the altitude module 60 to detect direction variation and elevation variation of the electronic device 1 and saves the detected information to the memory module 20 upon detecting that the distance between the current location and the nearest bifurcation point is less than the determination distance.

In block S16, the processor 10 determines whether the detected direction variation or the detected elevation variation of the electronic device 1 is different to the information stored in the map module 40.

In block S18, the alarm module 90 receives the alarm signal from the processor 10 and issues a notification to the a speaker or a display 30 upon detecting that the detected direction variation or the detected elevation variation of the electronic device 1 is different to the information stored in the map module 40.

In block S20, the processor 10 determines whether the current location is passed the closest bifurcation point in the navigation route upon detecting that the detected direction variation and the detected elevation variation of the electronic device 1 are same to the information stored in the map module 40.

In block S22, the processor 10 stops the direction module 50 and the altitude module 60 to detect direction variation and elevation variation of the electronic device 1 upon detecting that the current location is passed the closest bifurcation point in the navigation route.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device providing vehicle navigation, comprising a processor, a memory module, and a display, comprising:
a map module providing geographic information;
a GPS module operable to provide a current location of the electronic device;
a direction module operable to detect a direction variation of the electronic device;
an altitude module operable to detect an elevation variation of the electronic device; and
an alarm module operable to issue a notification upon detecting that the detected direction variation or the detected elevation variation of the electronic device is different from the geographic information stored in the map module.

2. The electronic device of claim 1, wherein the geographic information further comprises altitude information.

3. The electronic device of claim 1, wherein the electronic device further comprises a 3G module for locating a position of the electronic device.

4. The electronic device of claim 1, wherein the direction module is an electronic compass providing 3-axis information of the electronic device.

5. The electronic device of claim 1, wherein the altitude module is a G-sensor.

6. A navigation method using an electronic device, the electronic device comprising a map module, a memory module, a GPS module, a direction module, an altitude module and an alarm module, the navigation method comprising:
presetting a determination distance for checking a navigation route and a target location for navigation to the memory module;
reading geographic information from the map module;
determining whether information of a current location of the electronic device from the GPS module is currently being received;
estimating a navigation route between the current location and the target location if information of a current location of the electronic device from the GPS module is currently being received;
determining a closest bifurcation point in the navigation route;
calculating whether a distance between the current location and the closest bifurcation point is less than the determination distance;
starting the direction module and the altitude module to detect a direction variation and an elevation variation of the electronic device and saving the detected information to the memory module upon detecting that the distance is less than the determination distance;
determining whether the detected direction variation or the detected elevation variation of the electronic device is different to the information stored in the map module;
issuing a notification by the alarm module upon detecting that the detected direction variation or the detected elevation variation of the electronic device is different to the information stored in the map module.
determining whether the current location is passed the closest bifurcation point; and
stopping the direction module and the altitude module upon detecting that the current location of the electronic device is passed the closest bifurcation point.

7. The navigation method of claim 7, wherein the geographic information further comprises altitude information.

8. The navigation method of claim 7, wherein the receiving step further comprises receiving an estimated location of the electronic device from a 3G module upon detecting that the current location information from the GPS module is missed.

9. The navigation method of claim 7, wherein the direction module is an electronic compass providing 3-axis information of the electronic device.

10. The navigation method of claim 7, wherein the altitude module is a G-sensor.

11. A storage medium storing a set of instructions, the set of instructions capable of being executed by a processor to perform a navigation method using an electronic device, the method comprising:
preset a determination distance for checking a navigation route and a target location for navigation to the memory module;
read geographic information from the map module;
determine whether information of a current location of the electronic device from the GPS module is currently being received;
estimate a navigation route between the current location and the target location if information of a current location of the electronic device from the GPS module is currently being received;
determine a closest bifurcation point in the navigation route;
calculate whether a distance between the current location and the closest bifurcation point is less than the determination distance;
start the direction module and the altitude module to detect a direction variation and an elevation variation of the electronic device and save the detected information to the memory module upon detecting that the distance is less than the determination distance;
determine whether the detected direction variation or the detected elevation variation of the electronic device is different to the information stored in the map module;
issue a notification by the alarm module upon detecting that the detected direction variation or the detected elevation variation of the electronic device is different to the information stored in the map module.
determine whether the current location is passed the closest bifurcation point; and
stop the direction module and the altitude module upon detecting that the current location of the electronic device is passed the closest bifurcation point.

12. The storage medium of claim 11, wherein the geographic information further comprises altitude information.

13. The storage medium of claim 11, wherein the receive step further comprises receive an estimated location of the electronic device from a 3G module upon detecting that the current location information from the GPS module is missed.

14. The storage medium of claim 11, wherein the direction module is an electronic compass providing 3-axis information of the electronic device.

15. The storage medium of claim 11, wherein the altitude module is a G-sensor.
